(19) United States
(12) Patent Application Publication
(10) Pub. No.: US 2006/0282872 A1
(43) Pub. Date: Dec. 14, 2006

(54) Component-type video and digital audio extender

(76) Inventors: Madalin C. Cirstea, East Lyme, CT (US); Justin T. Gierke, Lakewood, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/147,772

(22) Filed: Jun. 8, 2005

(51) Int. Cl. H04N 7/173

(52) U.S. Cl. 725/131

(57) ABSTRACT

The present invention relates to a system and method for extending component-type video signals, audio signals and infrared remote signals, and more specifically to a system and method for extending component-type video and digital audio signals over three wire pairs, such as three of the four wire pairs of a Category 5 cable.

### FIELD OF THE INVENTION

The present invention relates to extending component-type video signals, audio signals and infrared remote signals, and more specifically to a system and method for extending component-type video signals, audio signals and infrared remote signals over a single 4-pair cable, such as a Category 5 (CAT5) cable.

### BACKGROUND OF THE INVENTION

The world of entertainment media has made a clear move from analog to digital, and is now in the process of transitioning from standard definition to high definition signals. Content providers now offer high definition broadcasts and local channels in most major markets are already available in high definition via over the air antennas.

High definition content receivers are often configured to take the received signal, whether from an over the air antenna or from a cable or satellite content provider, and generate output in the form of digital audio (DTS, AC-3, PCM, etc.) and component video (Y, Pr and Pb, where Y is the luminescence and Pr and Pb are the color components). It is becoming more common for homes and commercial structures to be configured such that television and audio systems are physically separated from accompanying content receivers. This physical separation necessitates the use of extension technology to transmit the component video and digital audio signals from content receivers to televisions and audio systems. Since it is not practical to run component video and digital audio wires throughout structures, and since the length of component video and digital audio wires are necessarily limited (when high quality cables are employed, component video is limited to approximately 250 feet and digital audio is limited to approximately 50 feet), extenders have been developed that utilize category 5 (CAT5) wires to transmit the component video and digital audio signals over extended distances.

A variety of audio and video CAT5 extension products are currently on the market. Each of the products on the market converts the digital audio and video signals from single-ended signals to differential signals in order to increase noise immunity. The differential signals are then transmitted over separate twisted pairs of the CAT5 cable. Thus, component video requires three twisted pairs and digital audio requires one twisted pair. CAT5 cable has only four twisted pairs. Thus, in order to transmit another signal, such as an infrared (IR) signal from a remote, a second CAT5 cable is required. It would be preferable if component video and digital audio could be extended over only three twisted pairs, thereby leaving a twisted pair available for transmission of IR signals, stereo audio, composite video, control signals, etc.

### BRIEF SUMMARY OF THE INVENTION

According to an aspect of the invention, there is provided a method for extending digital audio and component-type video signals over three wire pairs comprising: receiving a single-ended digital audio signal and a component-type video signal having three single-ended component signals; converting the received digital audio and component-type single ended signals to three differential signals; and sending the three differential signals over three wire pairs.

Also according to the present invention, there is provided a system for extending digital audio, component-type video and infrared signals over four wire pairs comprising: a local unit configured to receive digital audio and component-type video data and send the received digital audio and component-type video data over three wire pairs to a remote unit, the local unit being further configured to transmit infrared data received from the remote unit via one wire pair; and a remote unit configured to receive and transmit the digital audio and component-type video data sent over three wire pairs, the remote unit being further configured to receive infrared data transmitted by a remote control and send the received infrared data to the local unit via one wire pair.

Also according to the present invention, there is provided a system for extending digital audio and component-type video signals over three wire pairs comprising: a local unit configured to receive single-ended digital audio, Y, Pr and Pb signals, converting the digital audio, Y, Pr and Pb single ended signals to three differential signals, and send the three differential signals over three wire pairs to a remote unit; and a remote unit configured to receive three differential signals sent over three wire pairs and convert three differential signals to single-ended digital audio, Y, Pr and Pb signals.

### BRIEF DESCRIPTION OF THE DRAWINGS

FIG. 1 is a block diagram of a system with a component-type video and digital audio extender according to the present invention;

FIGS. 2A-C are diagrams illustrating the use of common mode voltage to transmit digital audio signals and showing exemplary signals at various points in the system;

FIG. 3 is a block diagram of a system with an alternative embodiment of a component-type video and digital audio extender according to the present invention;

FIGS. 4A-B are diagrams illustrating the use of common mode voltage to transmit Pr component-type video signals;

FIG. 5 is a flow chart generally illustrating an aspect of one embodiment of a method for extending component-type video, digital audio, stereo audio, and infrared signals over four wire pairs; and

FIG. 6 is a flow chart generally illustrating another aspect of one embodiment of a method for extending component-type video, digital audio, stereo audio, and infrared signals over four wire pairs.

### DETAILED DESCRIPTION OF THE INVENTION

The present invention relates to a method for extending digital audio and component-type video (e.g. Y, Pr and Pb video, RGsB video, RsGsBs video, and the like) signals over three wire pairs. While the description of the present invention centers around Y, Pr and Pb video, it should be understood by those of skill in the art that the invention is equally applicable to RGsB video, RsGsBs video, as well as other component-type video. When extending such signals over Category 5 (CAT5) wire, for example, only three of the four available wire pairs are required, thereby making the fourth wire pair available for digital audio. Like the existing art, component-type video and digital audio signals are converted from single-ended signals to differential signals to increase noise immunity, and are then sent over four wire pairs. Unlike the prior art, however, the four differential signals are transmitted over only three wire pairs, rather than four, leaving the fourth pair available for other data, such as that from a remote control, DDC data, or system command and control data.

For example, when converting the four single-ended signals to the three differential signals to be sent over only three pairs of wire, the fourth signal may be “encoded in” or “integrated into” one or all of the other three signals. This may be accomplished by intentionally inserting a type of “noise” on the other signals. The “encoding” is preferably performed such that when the signals are received, the encoded signal is not visible. This type of encoding can be accomplished by sending one of the single-ended signals as a differential signal over the common mode voltage of two other differential signals. By encoding one of the signals, only three pairs are required to send four signals. For example, the converted differential digital audio signal may be sent as the common mode voltage over the Pr wire pair and the Pb wire pair.

A digital audio signal is a unidirectional signal. It is a digital data stream having a bit rate corresponding to the frame rate that was employed during audio encoding. Common digital audio sources, such as DVDs and CD typically have a bit rate of approximately 6 Mbps. Video signals are also unidirectional. The video sync signal is embedded into the Y signal, but the common mode of each video amplifier is otherwise unused. With reference to component video (Y, Pr, Pr), the digital audio signal, once converted to a differential signal, can therefore be applied to the common mode control pin of differential amplifiers used to convert the Pb and Pr signal to differential signals. Accordingly, the converted differential Pb and Pr signals have embedded digital audio differential signals. The converted differential signals require only three wire pairs for transmission. The common mode voltage can then be extracted by a network of resistors. Once extracted, it can be converted from a differential signal to a single-ended signal by a differential to single-ended amplifier/converter. For example, a video amplifier can extract the video differential signal and the common mode voltage will be attenuated with the common mode rejection ratio (CMRR) factor of the amplifier.

Because only three pairs are used to transmit digital audio and component-type video data, additional data can be transmitted with the digital audio and component-type video data when using a CAT5 cable having four wire pairs. For example, the fourth wire pair on a CAT5 cable may be used to transmit a control signal, a stereo audio signal, or Display Data Channel (DDC) data. The control signal may include command and/or control information for the extension system or an infrared signal from a remote control device. In one embodiment, a stereo audio signal may be sent over the fourth pair in one direction while at least one infrared signal is time multiplexed with the stereo audio signal and sent over the fourth pair in the opposite direction.

To accomplish component-type video and digital audio extension over three wire pairs, a system including a local unit and a remote unit may be used. In the presently preferred embodiment, the local unit and remote unit are connected via a four pair cable, such as a CAT5 cable. The local unit is configured to receive single-ended digital audio and component-type video data, such as from a digital cable or satellite receiver. The local unit then converts the single-ended signals to differential signals and transmits one of the four differential signals as a common mode voltage so that only three wire pairs are required to send the four differential signals. The remote unit receives the signals over the three wire pairs and extracts the common mode voltage signal. The remote unit then converts the differential signals to single-ended signals matching the signals received by the local unit. The remote unit may also compensate for discrepancies in length of the video signals and signal loss.

In addition, the remote unit may receive infrared data transmitted by a remote control and send the received infrared data to the local unit via one wire pair. The local unit may then receive the infrared data sent via the one wire pair and transmit the received infrared data so that it can be received by the component(s) that are controlled by the remote control.

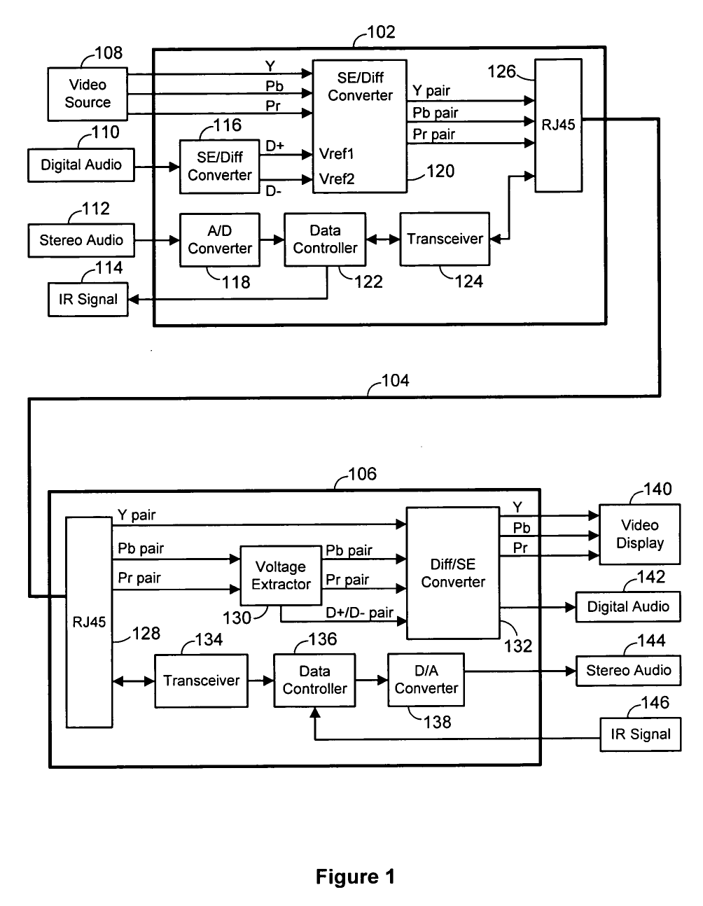

Turning initially to FIG. 1, a diagram of a system with a component video and digital audio extender is provided. The system includes a local unit 102 and a remote unit 106 connectable via a four wire pair cable 104, such as a CAT5 or CAT6 cable. The local unit 102 is connectable to a video source 108, such as a high definition video source, and a digital audio source 110. The local unit 102 may also be connected to a stereo audio source 112. In addition, the local unit 102 may be configured to transmit an infrared (IR) signal 114 corresponding to an IR signal 146 generated by a remote control.

The local unit 102 is preferably configured to receive single-ended component video (Y, Pb and Pr) signals and a single-ended digital audio signal. Accordingly, an audio converter 116 is a single-ended to differential converter that converts the single-ended digital audio signal to a differential signal (D+ and D− signals). A video converter 120 is also a single-ended to differential converter. The video converter 120 is configured to accept the Y, Pb and Pr single-ended signals, as well as the D+ and D− signals output by the audio converter 116.

The video converter 120 is preferably configured to convert each of the Y, Pb and Pr signals from single-ended to differential signals. In one embodiment, the video converter 120 is configured to differentiate the Pr signal by applying one of the D+ or D− signals to the common mode voltage of a differential amplifier and to differentiate the Pb signal by applying the other of the D+ or D− signals to the common mode voltage of another differential amplifier.

The video converter 120 preferably produces three differential signals—a Y pair, a Pb pair and a Pr pair-for transmission to a remote unit 106. The three differential signals are preferably placed on three wire pairs at an interface 126, such as an RJ45 interface, for transmission to a remote unit 106 via a cable 104 having at least three wire pairs, and preferably at least four wire pairs, such as a CAT5 cable.

The remote unit 106 is configured to receive at an interface 128 the three differential signals transmitted over the three wire pairs. The Pb and Pr pairs are preferably received at a voltage extractor 130, which is preferably configured to extract the D+/D− differential digital audio signal from the Pb and Pr signals transmitted over two wire pairs of the cable 104. The voltage extractor 130 preferably outputs Pb, Pr and D+/D− differential signals. A differential to single-ended converter 132 is then configured to receive the Y, Pb, Pr and D+/D− differential signals and convert the received signals to single-ended Y, Pb, Pr and digital audio signals corresponding to the signals received by the local unit 102. The differential to single-ended converter 132 may also perform frequency equalization to compensate for loss due to extension. The Y, Pb and Pr signals may then be sent to a video display 140 and the digital audio signal may be sent to a digital audio device 142, such as a surround sound receiver.

In addition to transmitting component video and digital audio over extended distances, the local unit 102 and remote unit 106 may also be configured to transmit IR data, such as that received from a remote control, over extended distances. The remote unit 106 may be configured to receive an IR signal 146, such as by way of an IR receiver, from a remote control and transmit the IR signal to the local unit 102, which may be configured to transmit the IR signal to the device or devices controlled by the remote control. Such transmission may be accomplished by any method known in the art. For example, the remote unit 106 may include a transceiver 134 for converting the IR signal into a form suitable for transmission over a single wire pair of the cable 104. The local unit 102 may also include a transceiver 124 for converting the received signal into a signal corresponding to the IR signal 146 received by the remote unit. The local unit 102 may also include an IR emitter to generate an IR signal 114 corresponding to the IR signal 146.

Other information can also be transmitted over the same wire pair as the IR signal. For example, a stereo audio signal and/or command and control information can also be transmitted on the single wire pair over which the IR signal is transmitted regardless of the direction of data. This type of transmission can be accomplished by any method known in the art and the diagram of FIG. 1 shows a system capable of such transmission.

As shown, an analog stereo audio signal is received at the local unit 102 from an analog stereo audio source 112. The stereo audio signal is then converted to a digital signal by an analog to digital (A/D) converter 118. The converted data is then sent to a data controller 122 wherein data flow is controlled. Since the IR signal and the stereo audio signal are both traveling on the same wire pair but in opposite directions, the data controller 122 controls the flow of the stereo audio signal and IR signal. For example, the IR signal and stereo audio signal may be multiplexed/demultiplexed at the data controller 122. In addition, the data controller 122 may send and receive command and control information to and from the data controller 136 of the remote unit 106 via the same wire pair over which the stereo audio signal and IR signal are transmitted.

The stereo audio signal (which may include command and control data) is then sent to the transceiver 124 where it is converted to a form suitable for transmission over the cable 104, after which it passes through an interface 126 and is transmitted to the remote unit 106 over a single wire pair of the cable 104. The remote unit 106 then receives the stereo audio signal at the interface 128, after which the stereo audio signal passes to the transceiver 134 and data controller 136. The data controller 136 functions in a manner similar to the data controller 122 and multiplexes/demultiplexes the stereo audio signal and IR signal. Once separated from the IR signal, the stereo audio signal is converted from a digital signal to an analog signal by a digital to analog (D/A) converter 138. After being converted to an analog signal, the stereo audio signal preferably corresponds to the stereo audio signal received by the local unit 102 and is transmitted to a stereo audio device, such as a stereo receiver, with the same voltage as the stereo audio signal received by the local unit 102.

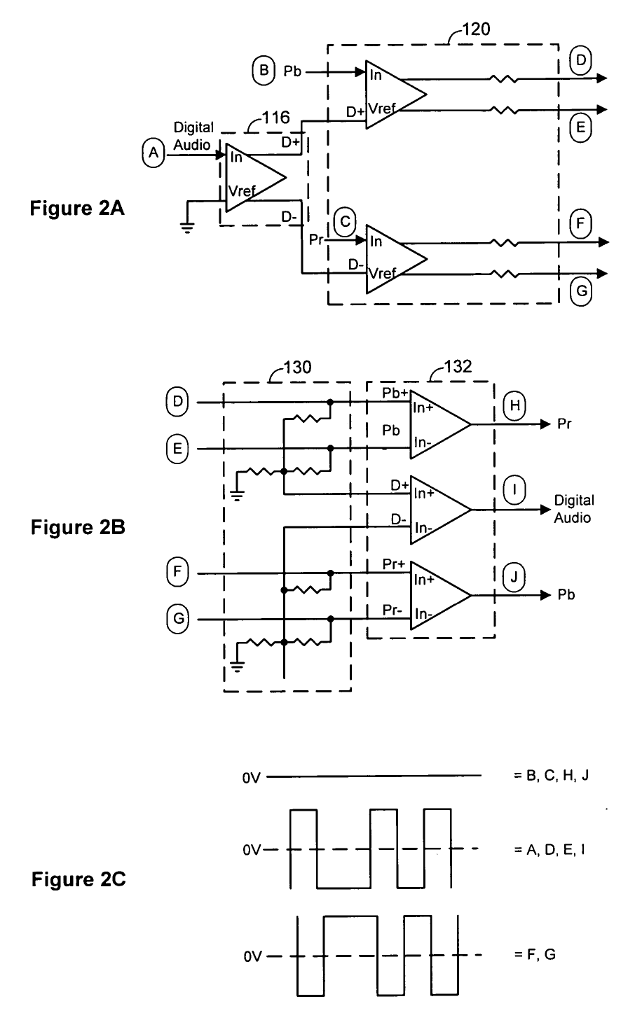

Turning next to FIGS. 2A-C, diagrams illustrating the use of common mode voltage to transmit digital audio signals and showing exemplary signals at various points in the system are provided. FIG. 2A illustrates the components of the local unit that combine three single-ended signals into two differential signals. FIG. 2B illustrates the components of the remote unit that separate two differential signals into three single-ended signals. FIG. 2C shows exemplary signals at various points of FIGS. 2A and 2B.

With reference to FIG. 2A, a single-ended digital audio signal shown as exemplary signal A is received by the audio converter 116. At the audio converter 116, the digital audio signal A is connected to the input of a differential amplifier and the reference voltage of the differential amplifier is connected to ground. The output of the differential amplifier is a differential signal having D+ and D− components. The D+ and D− signals are then used in the conversion of the Pb and Pr signals from single-ended to differential signals. For example, the Pb signal B is connected to the input of a differential amplifier and the D+ signal is connected to the reference voltage. A Pb pair differential signal having components D and E is then generated by the differential amplifier from the Pb and the D+ signals. The Pb pair signal can then be sent to the remote unit 106 via a single wire pair.

Similarly, the Pr signal C may be connected to the input of a differential amplifier and the D− is connected to the reference voltage. A Pr pair differential signal having components F and G is then generated by the differential amplifier from the Pr and the D− signals. The Pr pair signal can then be sent to the remote unit via a single wire pair. It will be understood by those skilled in the art that the D+ signal could be paired with the Pr signal or Y signal, rather than the Pb signal, and the D− signal could be paired with the Pb signal or Y signal, rather than the Pr signal.

As shown in FIG. 2B, the voltage extractor 130 of the remote unit 106 receives the Pb pair having components shown as D and E and the Pr pair having components shown as F and G. The voltage extractor 130 may be, for example, a network of resistors and is preferably designed to separate the Pb pair into Pb+, Pb− and D+ signals. Similarly, the voltage extractor 130 may be designed to separate the Pr pair into Pr+, Pr− and D− signals.

Following extraction, the Pb+, Pb−, Pr+, Pr−, D+and D− signals are converted to single-ended Pb, Pr and digital audio signals that correspond to the signals received by the local unit 102. Preferably, the Pb, Pr and digital audio signals are output by the remote unit 106 at the same voltages at which the Pb, Pr and digital audio signals were received by the local unit 102.

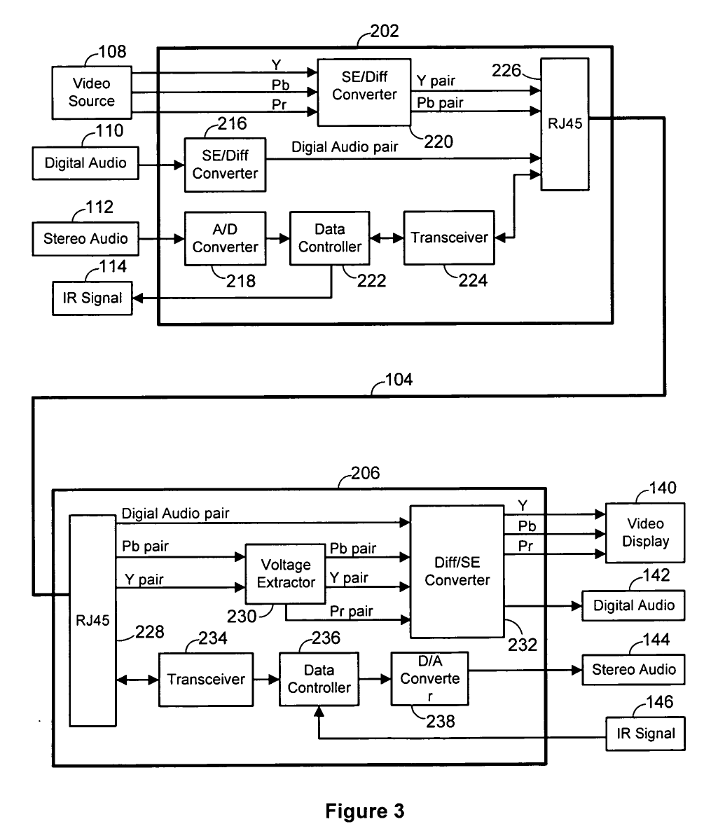

Turning next to FIG. 3, a diagram of a system with an alternate component video and digital audio extender is provided. Because the human eye is less sensitive to changes in the color red than other colors, one embodiment of the present invention uses the Y and Pb pairs to send Pr signal. Sending the Pr signal in this manner, as opposed to the Y or Pb signals, may reduce the perception of errors that may be induced on the signal sent over the common mode voltage due to less than ideal termination and skew between the differential signal components caused by discrepancies in the length of the wire pairs.

The system includes a local unit 202 and a remote unit 206 connectable via a four wire pair cable 104, such as a CAT5 or CAT6 cable. The local unit 202 is connectable to a video source 108, such as a high definition video source, and a digital audio source 110. The local unit 202 may also be connected to a stereo audio source 112. In addition, the local unit 202 may be configured to transmit an infrared (IR) signal 114 corresponding to an IR signal 146 generated by a remote control. 20 The local unit 202 is preferably configured to receive single-ended component video (Y, Pb and Pr) signals and a single-ended digital audio signal. Accordingly, an audio converter 216 is a single-ended to differential converter that converts the single-ended digital audio signal to a differential signal (D+ and D− signals). A video converter 220 is also a single-ended to differential converter and is configured to 25 accept the Y, Pb and Pr single-ended signals.

The video converter 220 is preferably configured to convert each of the Y, Pb and Pr signals from single-ended to differential signals. In one embodiment, the video converter 220 is configured to generate Pr+ and Pr− signals from the Pr single-ended signal and then differentiate the Y signal by applying one of the Pr+ or Pr− 30 signals to the common mode voltage of a differential amplifier and to differentiate the Pb signal by applying the other of the Pr+ or Pr− signals to the common mode voltage of another differential amplifier.

The video converter 220 preferably produces two differential signals—a Y pair and a Pb pair-for transmission to a remote unit 206. The Y pair, the Pb pair and the digital audio pair signals are preferably placed on three wire pairs at an interface 226, such as an RJ45 interface, for transmission to a remote unit 206 via a cable 104 having at least three wire pairs, and preferably at least four wire pairs, such as a CAT5 cable.

The remote unit 206 is configured to receive at an interface 228 the three differential signals transmitted over the three wire pairs. The Pb and Y pairs are preferably received by a voltage extractor 230, which is preferably configured to extract the Pr+/Pr− differential digital audio signal from the Pb and Y signals transmitted over two wire pairs of the cable 104. The voltage extractor 230 preferably outputs Y, Pb and Pr differential signals. A differential to single-ended converter 232 is then configured to receive the Y, Pb, Pr and D+/D− differential signals and convert the received signals to single-ended Y, Pb, Pr and digital audio signals corresponding to the signals received by the local unit 202. The differential to single-ended converter 232 may also perform frequency equalization to compensate for loss due to extension. The Y, Pb and Pr signals may then be sent to a video display 140 and the digital audio signal may be sent to a digital audio device 142, such as a surround sound receiver.

In addition to transmitting component video and digital audio over extended distances, the local unit 202 and remote unit 206 may also be configured to transmit IR data, stereo audio data, and/or command and control information over extended distances. This type of transmission is described above with reference to FIG. 1.

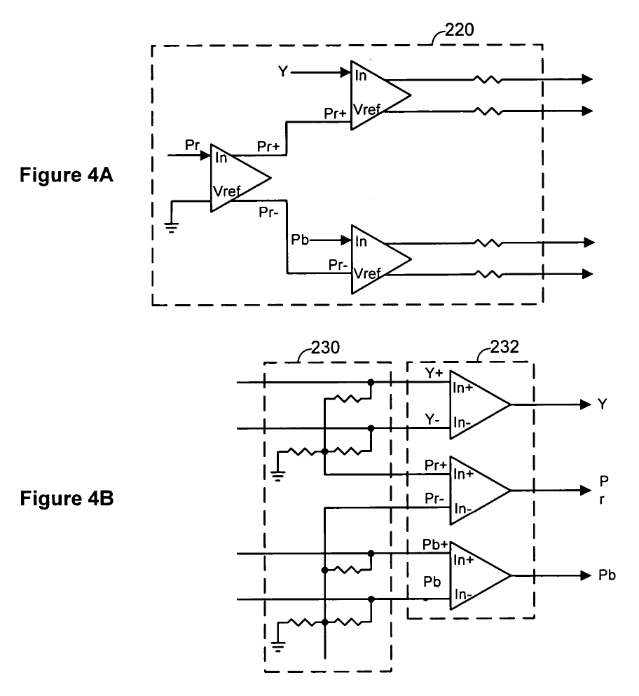

Turning next to FIGS. 4A-B, diagrams illustrating the use of common mode voltage to transmit Pr signals are provided. FIG. 4A illustrates the components of the local unit that combine three single-ended signals into two differential signals. FIG. 4B illustrates the components of the remote unit that separate two differential signals into three single-ended signals.

With reference to FIG. 4A, a single-ended Pr signal is received by the video converter 220. At the video converter 220, the single-ended Pr signal is connected to the input of a differential amplifier and the reference voltage of the differential amplifier is connected to ground. The output of the differential amplifier is a differential signal having Pr+ and Pr− components. The Pr+ and Pr− signals are then used in the conversion of the Pb and Y signals from single-ended to differential signals. For example, the Y signal is connected to the input of a differential amplifier and the Pr+ is connected to the reference voltage. A Y pair differential signal is then generated by the differential amplifier from the Y and the Pr+ signals. The Y pair signal can then be sent to the remote unit 206 via a single wire pair.

Similarly, the Pb signal may be connected to the input of a differential amplifier while the Pr− is connected to the reference voltage. A Pb pair differential signal is then generated by the differential amplifier from the Pb and the Pr− signals. The Pb pair signal can then be sent to the remote unit 206 via a single wire pair. It will be understood by those skilled in the art that the Pr+ signal could be paired with the Pb signal, rather than the Y signal, and the Pr− signal could be paired with the Y signal, rather than the Pb signal.

As shown in FIG. 4B, the voltage extractor 230 of the remote unit 206 receives the Y pair and the Pb pair. The voltage extractor 230 may be, for example, a network of resistors and is preferably designed to separate the Y pair into Y+ , Y− and Pr+ signals. Similarly, the voltage extractor 230 may be designed to separate the Pb pair into Pb+ , Pb− and Pr− signals.

Following extraction, the Y+, Y−, Pb+, Pb−, Pr+ and Pr− signals are converted to single-ended Y, Pb and Pr signals that correspond to the signals received by the local unit 102. Preferably, the Y, Pb and Pr signals are output by the remote unit 206 at the same voltages at which the Y, Pb and Pr signals were received by the local unit 202.

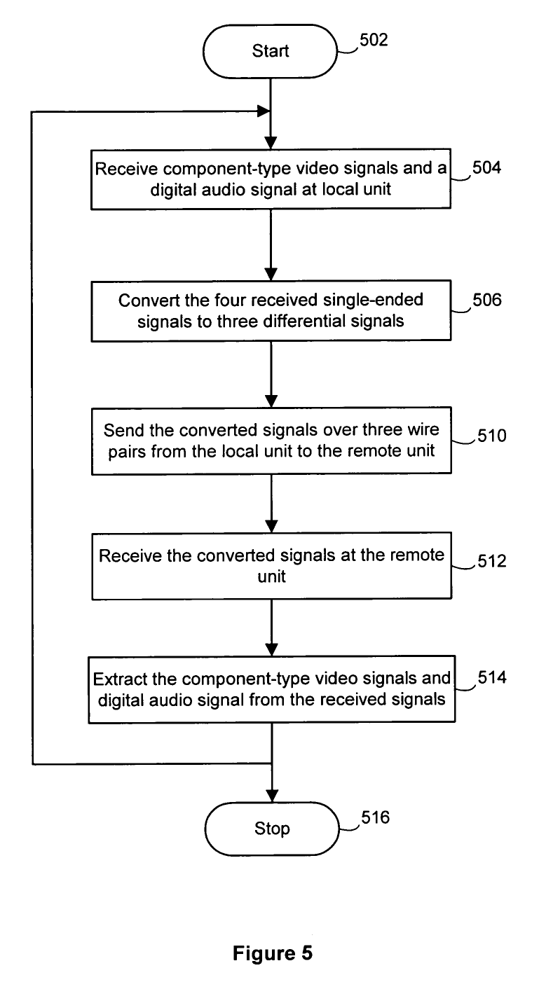

Turning next to FIG. 5, a flow chart generally illustrating an aspect of one embodiment of the data flow when extending component-type video, digital audio, stereo audio, and infrared signals over four wire pairs is provided. Flow begins at start block 502 from which progression continues to process block 504 wherein a local unit receives single-ended component-type video signals and a single-ended digital audio signal. Progression then flows to process block 506 wherein the received component video and digital audio signals are converted from four single-ended signals to three differential signals. Progression then flows to process block 510 wherein the converted component video signals and digital audio signals are sent over three wire pairs from the local unit to the remote unit. Flow then progresses to process block 512 wherein the converted signals are received at the remote unit. Progression then continues to process block 514 wherein the component-type video signals and digital audio signals are extracted from the received signals, after which progression terminates at termination block 516.

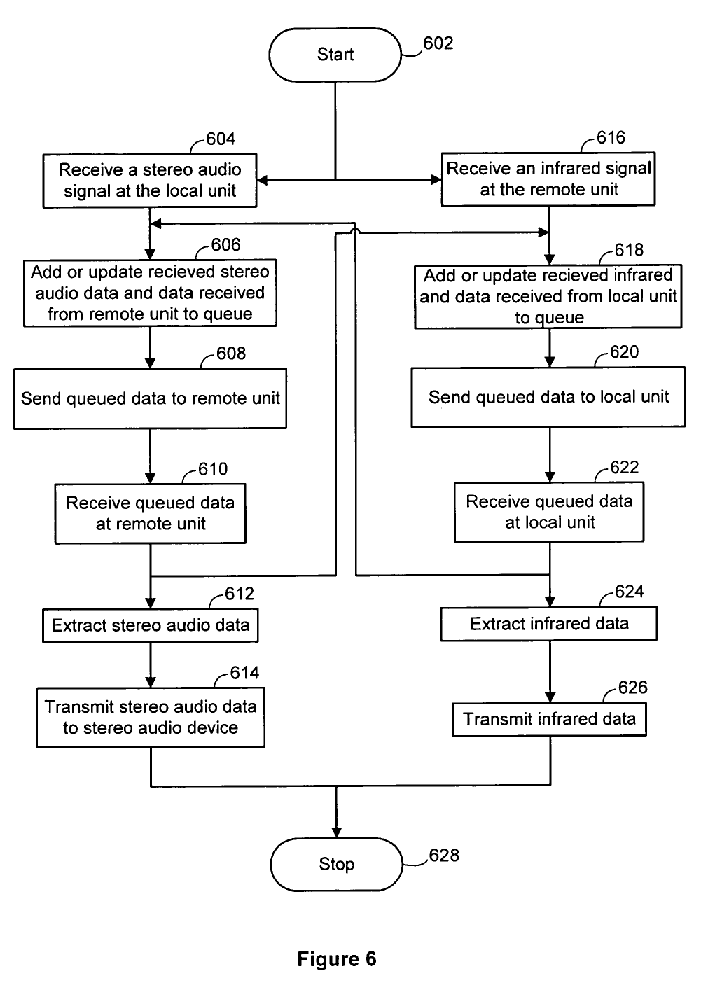

Turning next to FIG. 6, a flow chart generally illustrating another aspect of one embodiment of the data flow when extending component-type video, digital audio, stereo audio, and infrared signals over four wire pairs is provided. Flow begins at start block 602 from which progression continues to process block 604 wherein a stereo audio signal is received at the local unit. Flow also progresses from block 602 to block 616 wherein an infrared signal is received at the remote unit. Progression then flows from block 604 to block 606 wherein received stereo audio data and control data are added to the queue. Progression then continues to process block 608 wherein the queued data is sent to the remote unit.

Flow then progresses to process block 610 wherein the data sent by the local unit is received at the remote unit. Progression then continues to process block 612 wherein the stereo audio data is extracted from the received data. Progression also continues from process block 610 to process block 618. Following extraction of the stereo audio data, progression continues to process block 614 wherein the stereo audio data is transmitted to a stereo audio device. Flow then continues to termination block 628.

Following progression from block 602 to block 616 wherein an infrared signal is received at the remote unit, flow continues to process block 618 wherein received infrared data and control data are added to the queue. Progression then continues to process block 620 wherein the queued data is sent to the local unit.

Flow then progresses to process block 622 wherein the data sent by the remote unit is received at the local unit. Progression then continues to process block 624 wherein the infrared data is extracted from the received data. Progression also continues from process block 622 to process block 606. Following extraction of the infrared data, progression continues to process block 626 wherein the infrared data is transmitted. Flow then continues to termination block 628.

While the present invention has been described in association with several exemplary embodiments, the described embodiments are to be considered in all respects as illustrative and not restrictive. Such other features, aspects, variations, modifications, and substitution of equivalents may be made without departing from the spirit and scope of this invention which is intended to be limited solely by the scope of the following claims. Also, it will be appreciated that features and parts illustrated in one embodiment may be used, or may be applicable, in the same or in a similar way in other embodiments.

What is claimed is:

1. A method for extending digital audio and component-type video signals over three wire pairs comprising:
receiving a single-ended digital audio signal and a component-type video signal having three single-ended component signals;
converting the received digital audio and component-type single ended signals to three differential signals; and
sending the three differential signals over three wire pairs.

2. The method of claim 1 wherein the three single-ended component signals comprise one of: Y, Pr and Pb signals; R, Gs and B signals; or Rs, Gs and Bs signals.

3. The method of claim 1 further comprising receiving the three differential signals sent over the three wire pairs and converting the three differential signals to single-ended digital audio, three single-ended component signals of a component-type video signal.

4. The method of claim 1 wherein one of the three single-ended component signals of the component-type video signal or the digital audio signal is sent as a common mode voltage.

5. The method of claim 4 wherein the digital audio is sent as a common mode voltage.

6. The method of claim 5 wherein the three single-ended component signals are Y, Pr and Pb signals and the digital audio is sent as a common mode voltage over a Pr wire pair and a Pb wire pair.

7. The method of claim 4 wherein the three single-ended component signals are Y, Pr and Pb signals the Pr signal is sent as a common mode voltage.

8. The method of claim 1 further comprising sending over the fourth pair at least one of: at least one control signal, a stereo audio signal, or DDC data.

9. The method of claim 8 wherein the control signal comprises at least one of: command information, control information, video compensation information, or an infrared signal from a remote control device.

10. The method of claim 9 wherein both a stereo audio signal and at least one infrared signal are sent over the fourth pair and wherein the stereo audio signal is sent over the fourth pair in one direction and the at least one infrared signal is sent over the fourth pair in the opposite direction.

11. The method of claim 10 wherein the infrared signal and stereo audio signal are time multiplexed.

12. A system for extending digital audio, component-type video and infrared signals over four wire pairs comprising:
a local unit configured to receive digital audio and component-type video data and send the received digital audio and component-type video data over three wire pairs to a remote unit, the local unit being further configured to transmit infrared data received from the remote unit via one wire pair; and
a remote unit configured to receive and transmit the digital audio and component-type video data sent over three wire pairs, the remote unit being further configured to receive infrared data transmitted by a remote control and send the received infrared data to the local unit via one wire pair.

13. The method of claim 12 wherein the component-type video data signals comprise one of: Y, Pr and Pb signals; R, Gs and B signals; or Rs, Gs and Bs signals

14. The system of claim 12 wherein the component-type video data comprises Y, Pr and Pb signals and one of the Y, Pr, and Pb signals is sent as a common mode voltage on the other two signals.

15. The system of claim 12 wherein the digital audio data is sent as a common mode voltage.

16. The system of claim 12 wherein the digital audio and component-type video signals received by the local unit are single-ended signals and the local unit is further configured to convert the received single-ended digital audio and component-type video signals to differential signals.

17. The system of claim 12 wherein the local unit is configured to convert four single-ended signals to three differential signals.

18. The system of claim 12 wherein the local unit is further configured to receive stereo audio data from an audio source and transmit the stereo audio data via the one wire pair over which infrared data is received.

19. The system of claim 12 further comprising a four wire pair communications channel.

20. A system for extending digital audio and component-type video signals over three wire pairs comprising:
a local unit configured to receive single-ended digital audio, Y, Pr and Pb signals, converting the digital audio, Y, Pr and Pb single ended signals to three differential signals, and send the three differential signals over three wire pairs to a remote unit; and
a remote unit configured to receive three differential signals sent over three wire pairs and convert three differential signals to single-ended digital audio, Y, Pr and Pb signals.

21. The system of claim 20 wherein the digital audio data is sent as a common mode voltage.

22. The system of claim 20 wherein one of the Y, Pr, and Pb signals is sent as a common mode voltage over the other two.

23. The system of claim 20 wherein the local unit is further configured to receive stereo audio data from an audio source and the remote unit is configured to receive infrared data from a remote control, and wherein the local unit and remote unit are configured to transmit the received stereo audio data and infrared data via the one wire pair.
